(19) United States
(12) Patent Application Publication
(10) Pub. No.: US 2017/0173592 A1
(43) Pub. Date: Jun. 22, 2017

(54) DEBRIS TRAPPING MAGNET CONFIGURATION

(71) Applicant: GM Global Technology Operations LLC, Detroit, MI (US)

(72) Inventors: Mauricio C. Vituri, Sao Bernardo Do Campo (BR); Hildegar Espada, Sao Paulo (BR); Ricardo Camargo, Santo André (BR)

(21) Appl. No.: 14/978,761

(22) Filed: Dec. 22, 2015

(51) Int. Cl. B03C 1/30; B03C 1/14; F16H 57/04

(52) U.S. Cl. CPC B03C 1/30; F16H 57/0404; B03C 1/14; B03C 2201/18; B03C 2201/20

(57) ABSTRACT

A debris collecting and retaining magnet structure for removable disposition in a motor vehicle transmission. The magnet structure is cylindrical and defines a plurality of axially and circumferentially extending and intersecting bars or ribs. The intersecting bars or ribs form a cylindrical cage. The cage is secured to a mounting structure having a radially extending arm or lug with a mounting opening in which a threaded fastener may be installed to secure the magnet assembly to a transmission housing. The mounting structure includes a gasket such as an O-ring to seal it within the transmission. The cylindrical magnet cage exhibits significantly increased surface area relative to conventional magnets thereby increasing the amount of metal particles that may be attracted to and retained by the magnet.

### FIELD

The present disclosure relates to debris collecting and retaining magnets for motor vehicle transmissions and more particularly to a novel and non-obvious configuration for a debris collecting and retaining magnet configuration for motor vehicle transmissions.

### BACKGROUND

The statements in this section merely provide background information related to the present disclosure and may or may not constitute prior art.

It has long been known that metallic particles from various components of a motor vehicle transmission such as gears, shafts, bearings, clutches, synchronizers, brakes, shift rails and even the transmission housing itself can break off and circulate in the transmission fluid. Moreover, and in spite of a manufacturer's best efforts to clean them, some metallic particles may remain on machined parts that are assembled into the transmission. Notwithstanding the much higher density of such particles relative to the transmission fluid which suggests that they will sink to the bottom of the transmission during periods of vehicle inactivity, given the relatively significant forces and fluid flows within an operating transmission, even if the particles have settled out, they will generally be disturbed and again circulate with the fluid flow, harm other components and may reduce the service life of the transmission.

It is also generally known that since many of these components are fabricated of iron, steel, other ferrous alloys or other magnetic materials, they can relatively easily be collected by a permanent magnet disposed within the transmission. The difficulty of this approach is three fold. First of all, modern transmissions tend to be quite compact and thus suitably locating such a magnet so that is is reasonable exposed to fluid flow may be difficult. Second of all, even if a suitable location is found, the space available for the magnet may be limited and thus the size and surface area of the magnet exposed and available to collect particles may also be limited. Last of all, the magnet may be located so that it is both inaccessible and thus unreplaceable. Accordingly, as the magnet collects particles and becomes covered with an increasingly thick layer of such particles, it becomes increasingly ineffective and eventually ceases to provide its function. In order to clean or replace the magnet, it may be necessary to open the transmission case.

The present invention addresses and solves these difficulties.

### SUMMARY

The present invention provides an improved debris collecting and retaining magnet structure for disposition in a motor vehicle transmission. The magnet structure is cylindrical in form and defines a plurality of axially and circumferentially extending and intersecting bars or ribs. The intersecting bars or ribs form a cylindrical cage. The cage is secured to a mounting structure having a radially extending arm or lug with a mounting opening in which a threaded fastener may be installed to secure the magnet assembly to a transmission housing. The mounting structure includes a gasket to seal it within the transmission. The cylindrical magnet cage exhibits significantly increased surface area relative to conventional magnets thereby increasing the amount of metal particles that may be attracted to and retained by the magnet. Additionally, since the magnet cage assembly is readily removable from the transmission, the magnet cage is easily inspected and serviced to remove collected debris, thereby greatly extending the effective service life of the debris collecting magnet as well as the transmission.

The invention also includes an additional embodiment: the debris trapping magnet cage without the mounting arm or lug that may be mounted to any suitable internal surface at any suitable location within the transmission.

Thus it is an aspect of the present invention to provide a debris trapping magnet for a motor vehicle transmission.

It is a still further aspect of the present invention to provide a metal particle collecting and retaining magnet for a motor vehicle transmission.

It is a still further aspect of the present invention to provide a debris trapping magnet having a plurality of axially and circumferentially extending and intersecting bars or ribs.

It is a still further aspect of the present invention to provide a debris trapping magnet having a plurality of axially and circumferentially extending and intersecting bars or ribs forming a cage.

It is a still further aspect of the present invention to provide a debris trapping magnet having a plurality of axially and circumferentially extending and intersecting bars or ribs forming a cylindrical cage.

It is a still further aspect of the present invention to provide a debris trapping magnet having a plurality of axially and circumferentially extending and intersecting bars or ribs having a mounting structure such as a radially extending arm or lug and a gasket.

It is a still further aspect of the present invention to provide a debris trapping magnet having a plurality of axially and circumferentially extending and intersecting bars or ribs which form a cylindrical cage having a mounting structure such as a radially extending arm or lug with a mounting opening.

It is a still further aspect of the present invention to provide a debris trapping magnet having a plurality of axially and circumferentially extending and intersecting bars or ribs which form a cylindrical cage having a gasket and a mounting feature such as a radially extending arm or lug having a mounting opening.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a portion of a transmission housing and a removable debris trapping magnet cage assembly according to the present invention;

FIG. 2 is an enlarged perspective view of a debris trapping magnet cage assembly according to the present invention;

FIG. 3 is a perspective view of a debris trapping magnet cage and mounting bolt according to the present invention; and

FIGS. 4A and 4B are sectional views of a magnet cage according to the present invention taken along lines A-A and B-B, respectively, of FIG. 3.

### DETAILED DESCRIPTION

The following description is merely exemplary in nature and is not intended to limit the present disclosure, application, or uses.

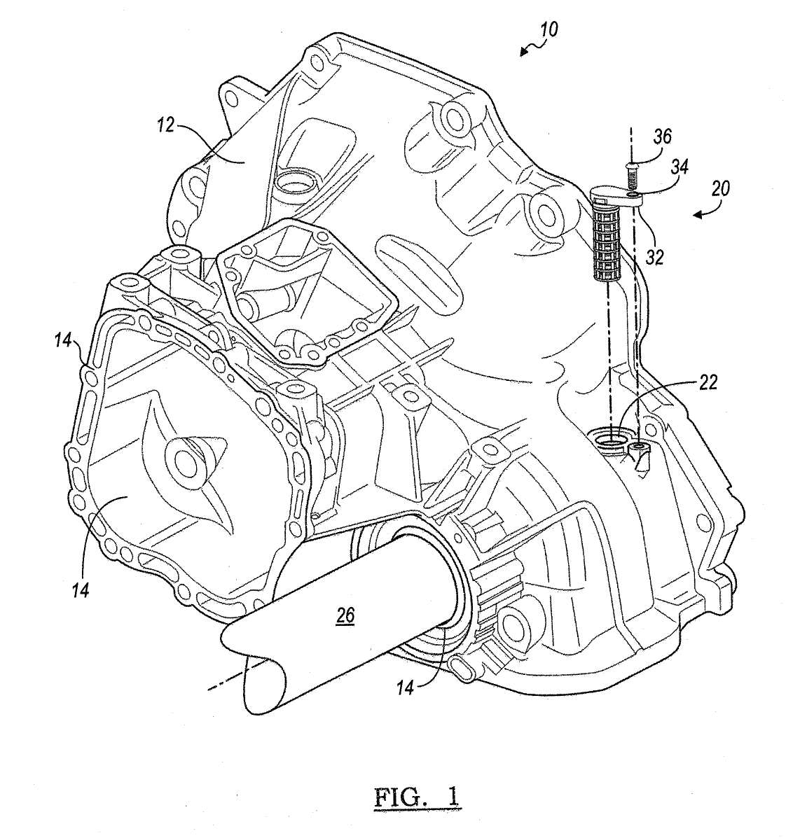

With reference now to FIG. 1, a motor vehicle transmission adapted to receive a debris trapping magnet cage assembly according to the present invention is illustrated and generally designated by the reference number 10. The motor vehicle transmission 10 includes a typically cast metal housing 12 having various openings, passageways, shoulders, flanges and the like 14 which receive, locate and protect the various components such as shafts, gears, bearings, synchronizers, clutches and brakes (not illustrated) of the transmission 10.

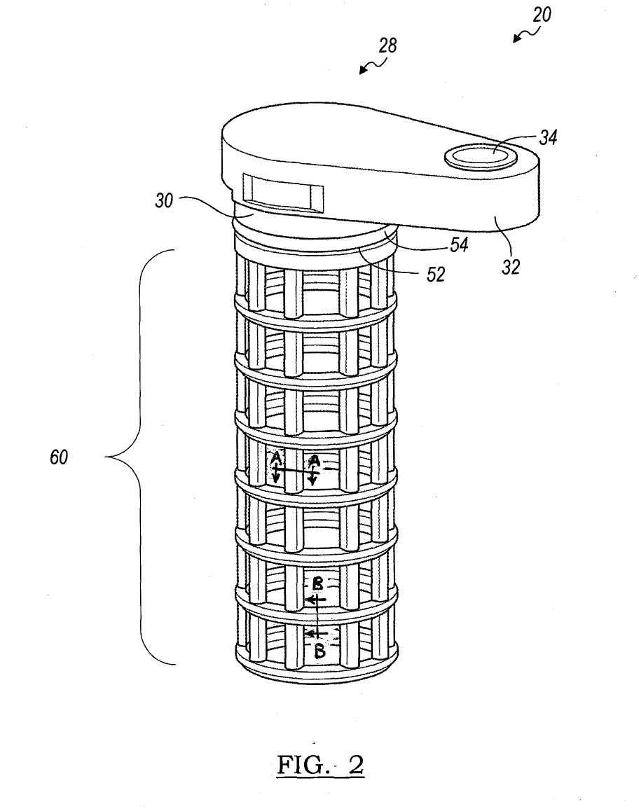

Referring now to FIGS. 1 and 2, one such component is a debris trapping magnet cage assembly 20 which is received within an opening 22 in the transmission housing 12 and may be radially aligned with a gear (not illustrated) on an output shaft 26 or other rotating component of the transmission 10 to provide good fluid circulation near and around the debris trapping magnet cage assembly 20. The debris trapping magnet cage assembly 20 includes a body or mounting structure 28 having a short cylindrical portion 30 and a radially extending mounting arm or lug 32 having an opening 34 adapted to receive a threaded fastener such as a machine screw 36 which secures the debris trapping magnet cage assembly 20 to the transmission 10.

Disposed on the cylindrical portion 30 of the body 28 adjacent the mounting arm or lug 32 is circumferential groove 52 which receives and retains an elastomeric gasket or seal 54 such as a O-ring which provides a fluid tight seal when the debris trapping magnet cage assembly 20 is disposed in the opening 22 of the transmission 10. Secured to the cylindrical portion 30 of the body 28 adjacent the circumferential groove 52 and gasket or seal 54 by any suitable means, such as a press or interference fit or an adhesive, and extending away from the mounting arm or lug 32 is a debris trapping magnet cage 60. The magnet cage 60 is preferably cylindrical and defines an inside diameter the same as or just slightly smaller than the outside diameter of the cylindrical portion 30 of the body 28.

The magnet cage 60 includes a plurality of axially extending, circumferentially spaced apart parallel ribs or bars 62 which intersect a plurality of axially spaced apart circumferentially extending bars or ribs 64. Preferably, the magnet cage 60 is fabricated of hard ferrite 26/24 (DIN IEC 60404-8-1) or a magnetic material having similar characteristics. The magnet cage 60 may be fabricated by powdered metal manufacturing techniques. The axial and circumferential bars or ribs 62 and 64 form an open cage having significantly greater surface area than any prior art plug or button magnet and thus are capable of collecting and retaining a significantly higher volume or quantity of debris or metallic particles. Thus, the useful and effective life of the debris trapping magnet cage 60 is much longer than that of a prior art plug or button magnet. Such extended life, in turn, extends the life of the transmission 10. Since the debris trapping magnet 60 is readily removable, for example, for inspection or cleaning, this feature further extends its useful and effective life.

Referring briefly to FIGS. 4A and 4B, representative cross sections of the vertical or axial bars or ribs 62 and the circumferential or horizontal bars or ribs 64, respectively, are illustrated. In FIG. 4A, the axial bars or ribs are seen to have a semi-circular cross section although other cross sections, such as substantially square or triangular, may be utilized. In FIG. 4B, the circumferential bars or ribs 64 preferably have flat upper, lower and inner surfaces.

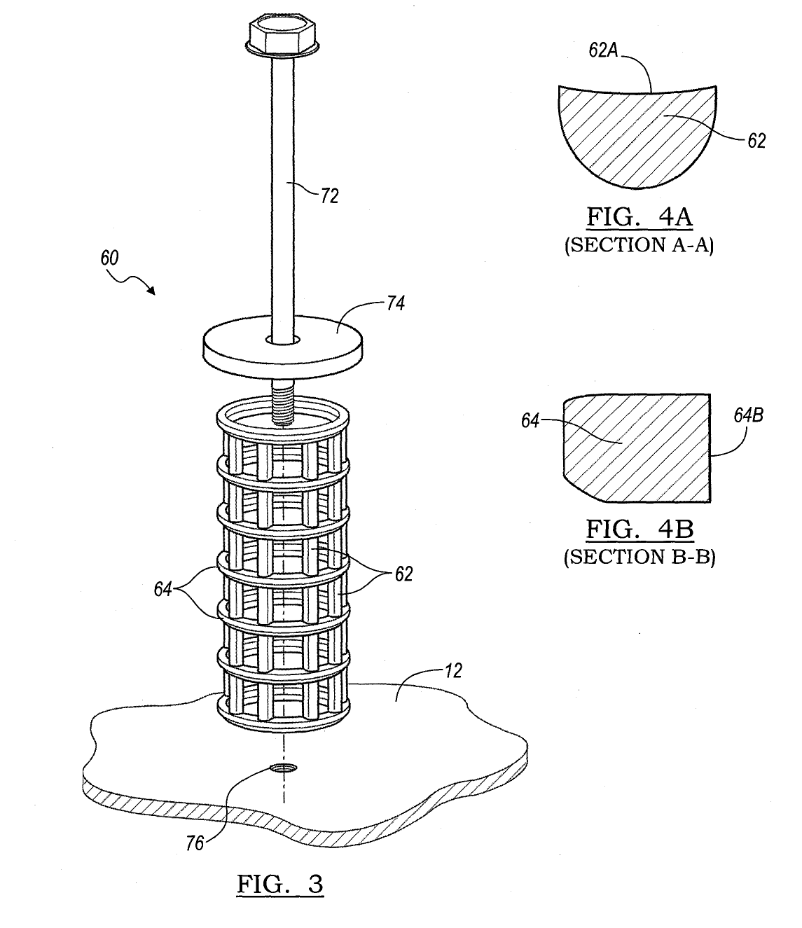

Referring now to FIG. 3, and notwithstanding the foregoing description, it should be understood that the debris trapping magnet cage 60 is a stand-alone device having an additional embodiment. The additional embodiment comprises just the magnet cage 60 that may be mounted or secured semi-permanently to an interior surface of the transmission housing 12, if desired. As used here, the word “semi-permanently” means removable but not readily serviceable or accessible as described above. That is, it may be mounted in a location where the magnet cage 60 is only accessible, for example, when an access plate or a portion of the transmission housing 12 is removed or disassembled. The magnet cage 60 may be secured to the transmission housing 12 by a threaded fastener 72 such as a bolt or machine screw having a length longer than the axial length of the magnet cage 60 and a washer 74 disposed between the head of the fastener and the magnet cage 60. The fastener 72 is threaded into a complementarily threaded opening 76 in the transmission housing 12.

The description of the invention is merely exemplary in nature and variations that do not depart from the gist of the invention are intended to be within the scope of the invention. Such variations are not to be regarded as a departure from the spirit and scope of the invention.

What is claimed is:

1. A debris trapping magnet for a motor vehicle transmission comprising, in combination,
a cylindrical body including a first plurality of axially extending ribs intersecting a second plurality of circumferentially extending ribs,
whereby said first and second pluralities of ribs form a cage having a third plurality of openings between said first and second pluralities of ribs.

2. The debris trapping magnet of claim 1 wherein said cylindrical body is fabricated of hard ferrite magnetic material.

3. The debris trapping magnet of claim 1 wherein said magnet is disposed on an inner surface of said motor vehicle transmission.

4. The debris trapping magnet of claim 1 further including a mounting lug secured to said cylindrical body, said mounting lug extending radially from said body and including a through opening adapted to receive a fastener.

5. The debris trapping magnet of claim 1 further including a mounting structure secured to said cylindrical body, said mounting structure including a circumferential groove and an elastomeric seal disposed in said groove.

6. The debris trapping magnet of claim 1 further including a threaded fastener having a length greater than the axial length of said cylindrical body and adapted to secure said body to an interior surface of a transmission.

7. A debris trapping magnet assembly for a motor vehicle transmission comprising, in combination,
a mounting body having a radially extending mounting lug, a circumferential groove and an elastomeric seal disposed in said groove, and
a debris trapping magnet secured to said body, said magnet including a first plurality of axially extending ribs intersecting a second plurality of circumferentially extending ribs,
whereby said first and second pluralities of ribs form a cage having a third plurality of openings between said first and second pluralities of ribs.

8. The debris trapping magnet assembly of claim 7 wherein said cage is fabricated of hard ferrite magnetic material.

9. The debris trapping magnet assembly of claim 7 wherein said assembly is disposed in an opening in a transmission and said elastomeric seal provides a fluid tight seal between said mounting body and opening is said transmission.

10. The debris trapping magnet assembly of claim 7 wherein said magnet includes at least six axially extending ribs and six circumferentially extending ribs.

11. The debris trapping magnet assembly of claim 7 wherein said axially extending ribs have a partially circular cross section.

12. The debris trapping magnet assembly of claim 7 further including a through opening in said mounting lug adapted to receive a fastener.

13. A debris trapping magnet assembly, comprising, in combination,
a body having a cylindrical portion and a mounting lug extending radially from said body, a circumferential groove in said cylindrical portion and an elastomeric seal disposed in said groove, and
a magnet body secured to said cylindrical portion and including a first plurality of axially extending ribs intersecting a second plurality of circumferentially extending ribs,
whereby said first and second pluralities of ribs form a cage having a third plurality of openings between said first and second pluralities of ribs.

14. The debris trapping magnet assembly of claim 13 wherein said magnet body is fabricated of hard ferrite magnetic material.

15. The debris trapping magnet assembly of claim 13 further including a through opening in said mounting lug adapted to receive a fastener.

16. The debris trapping magnet assembly of claim 13 wherein said magnet body includes at least six axially extending ribs and six circumferentially extending ribs.
